(19) United States
(12) Patent Application Publication
(10) Pub. No.: US 2019/0266540 A1
(43) Pub. Date: Aug. 29, 2019

(54) METHOD AND SYSTEM FOR TRACKING HEALTH STATISTICS

(71) Applicant: INTERNATIONAL BUSINESS MACHINES CORPORATION, Armonk, NY (US)

(72) Inventor: David A. Foster, Chelsea, MI (US)

(21) Appl. No.: 16/409,429

(22) Filed: May 10, 2019

Related U.S. Application Data
(63) Continuation of application No. 15/720,275, filed on Sep. 29, 2017.

(51) Int. Cl. G06Q 10/06; G06Q 50/22

(52) U.S. Cl. CPC G06Q 10/06395; G06Q 50/22

(57) ABSTRACT

A computer program product for modeling a quality of healthcare based on a level of consolidation of a healthcare region is disclosed. The program causes a processor to identify a plurality of healthcare regions comprising healthcare providers and access healthcare statistics of a plurality of patients in the plurality of healthcare regions. The processor accesses a consolidation index for each of the healthcare regions and calculates a correlation of at least one care factor of the healthcare statistics to the consolidation index. The processor generates a consolidation influence model for the at least one care factor based on the correlation.

### RELATED APPLICATIONS

This application is a continuation of U.S. patent application Ser. No. 15/720,275, filed Sep. 29, 2017, the entire content of which is incorporated by reference herein.

### BACKGROUND

The present invention relates to a method and system configured to analyze health statistics, and, more specifically, to a method and system to track health statistics in relation to consolidation levels.

### SUMMARY

According to an embodiment of the present invention, a computer program product for modeling a quality of healthcare based on a level of consolidation of a healthcare region is disclosed. The computer program product comprises a computer readable storage medium having program instructions embodied therewith. The program instructions are executable by a processor. The program instructions cause the processor to identify a plurality of healthcare regions comprising healthcare providers. The healthcare providers comprise varying proportions of market share in the plurality of healthcare regions. The program instructions further cause the processor to access a plurality of patient records in at least one database. The patient records indicate healthcare statistics of a plurality of patients in the plurality of healthcare regions. The processor may further calculate a consolidation index for each of the healthcare regions. The consolidation index indicates a level of diversity of the healthcare providers forming a cumulative total of the market shares in each of the healthcare regions.

With the consolidation index for each of the regions, the processor may further calculate a correlation of at least one care factor of the healthcare statistics to the consolidation index for the plurality of healthcare regions and generate a consolidation influence model for the at least one care factor based on the correlation. The consolidation influence model identifies a relationship between the at least one care factor and the consolidation index among the plurality of healthcare regions. The processor may further apply the consolidation influence model to predict a change in the at least one care factor based on a change in the consolidation index in a healthcare region of interest. The healthcare region of interest may be identified by a user of the computer program as an input or identified by the processor. The healthcare region of interest may comprise a plurality of healthcare providers of interest.

According to another embodiment of the present invention, a computerized method for determining a market consolidation strategy for a healthcare market is disclosed. The method comprises identifying, by a processor, a plurality of healthcare regions comprising healthcare providers and accessing, by the processor, at least one database comprising a plurality of healthcare statistics of a plurality of patients in the plurality of healthcare regions. The method may further comprise calculating, by the processor, a consolidation index for each of the healthcare regions. The consolidation index indicates a level of diversity of the healthcare providers in each of the healthcare regions.

With the consolidation index for each of the healthcare regions, the method may further comprise calculating, by the processor, a correlation of at least one care factor of the healthcare statistics to the consolidation index of each of the plurality of healthcare regions and generating a consolidation influence model for the at least one care factor based on the correlation. The consolidation influence model identifies a relationship between the at least one care factor and the consolidation index among the plurality of healthcare regions. The method may further comprise receiving, by the processor, an indication of a healthcare region of interest and calculating, based on the consolidation influence model, a consolidation prediction for the healthcare region of interest. The processor may further control an output of the consolidation prediction via a reporting interface.

According to yet another embodiment of the present invention, a computer program product for modeling a quality of healthcare based on a level of consolidation of a healthcare region is disclosed. The computer program product comprises a computer readable storage medium having program instructions embodied therewith. The program instructions are executable by a processor. The program instructions cause the processor to identify a plurality of healthcare regions comprising healthcare providers and access healthcare statistics of a plurality of patients in the plurality of healthcare regions. The program instructions may further instruct the processor to access a consolidation index for each of the healthcare regions and calculate a correlation of at least one care factor of the healthcare statistics to the consolidation index for the plurality of healthcare regions. The program instructions may further instruct the processor to generate a consolidation influence model for the at least one care factor based on the correlation. The consolidation influence model identifies a statistical relationship between the at least one care factor and the consolidation index among the plurality of healthcare regions. By applying the consolidation influence model, the processor may predict a change in the at least one care factor in an identified healthcare region based on prospective change in the consolidation index in the identified healthcare region.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a block diagram demonstrating a plurality of healthcare regions comprising care providers and medical centers;

FIG. 2 is a block diagram demonstrating a system for modeling healthcare statistics based on a level of market consolidation;

FIG. 3 is a process diagram demonstrating a method for modeling healthcare statistics based on market consolidation;

FIG. 4 is a flowchart demonstrating a method of correlation processing for healthcare statistics based on market consolidation; and

FIG. 5 is a schematic diagram demonstrating a plurality of healthcare regions with varying levels of market consolidation in accordance with the disclosure.

### DETAILED DESCRIPTION

The disclosure provides for a computer-based method and system for healthcare providers to track health statistics based on levels of market consolidation. As discussed herein, market consolidation may be defined by a number of metrics and generally refers to a level of diversity of healthcare providers in healthcare regions and the proportion of market share held by each of the healthcare providers in each of the healthcare regions. In an exemplary embodiment, the methods and systems described herein are configured to track the effects of market consolidation of one or more care factors for a region of interest. The care factors may correspond to a variety of quality or financial factors that may be utilized to define a comparative level of healthcare quality provided by the healthcare providers in each of the healthcare regions. Accordingly, the disclosure may provide for techniques and systems that may be utilized to calculate the independent effect of market consolidation via a consolidation influence model in order to provide insight and predictions demonstrating the impact of consolidation on healthcare regions in general and/or specific healthcare regions of interest.

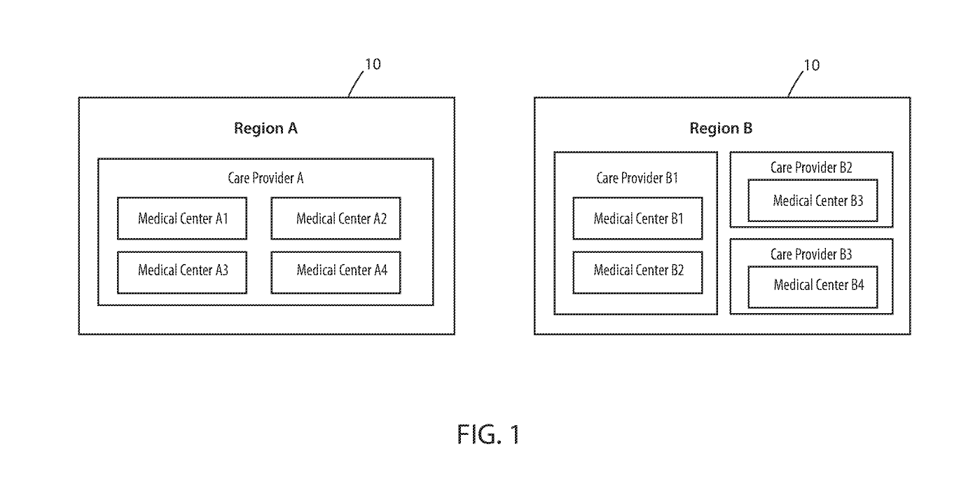

With reference now to FIG. 1, a block diagram demonstrating a plurality of healthcare regions 10 is shown. The healthcare regions 10 demonstrate differing levels of market consolidation. For example, region A corresponds to a completely consolidated healthcare market comprising only care provider A. Within region A, care provider A operates a plurality of medical centers denoted as medical center A1, medical center A2, medical center A3, and medical center A4. In contrast, region B corresponds to a diverse region having a lower level of market consolidation compared to region A. As illustrated, region B comprises a plurality of care providers including care provider B1, care provider B2, and care provider B3. Each of the care providers in region B comprises at least one medical center.

In this particular example, care provider B1 operates medical center B1 and medical center B2. Care provider B2 operates medical center B3, and care provider B3 operates medical center B4. Accordingly, each of the healthcare regions 10 demonstrated in FIG. 1 represents a differing level of market consolidation. The disclosure may provide for systems and methods configured to identify the influence or relationship that the variations in the market consolidation exemplified in FIG. 1 have on various care factors. The care factors may indicate a comparative level of care provided by the care providers (e.g. care provider A, care provider B1) in each of the healthcare regions 10.

As discussed herein, the healthcare regions 10 may flexibly be defined to suit an objective of a consolidation influence model applied in accordance with the disclosure. For example, the healthcare regions 10 may be defined as state boundaries or metropolitan areas depending upon a region or type of region to be analyzed by the consolidation influence model as discussed herein. In some specific examples, the healthcare regions 10 may be defined based on Core-Based Statistical Areas (CBSA) as defined by United States geographic studies defined by the Office of Management and Budget (OMB). Such healthcare regions 10 may focus on metropolitan or areas anchored by urban centers of at least 10,000 people in adjacent communities. Additionally, the healthcare regions 10 may be defined as Dartmouth Atlas healthcare regions, hospital referral regions, hospital service areas, etc. Accordingly, the methods and systems discussed herein may be flexibly applied to analyze the comparative effects of market consolidation on the various healthcare regions 10 depending on an analysis objective.

Once the healthcare regions 10 are identified, a consolidation index for each of the healthcare regions 10 may further be defined. As discussed in reference to the healthcare regions 10 demonstrated in FIG. 1, region A has a significantly higher level of market consolidation than region B. Accordingly, the systems and method discussed herein may calculate and/or access various metrics indicating the level of consolidation or consolidation index of each of the healthcare regions 10. One example of a consolidation index is the Herfindahl-Hirschman Index (HHI).

In reference to the healthcare regions 10, the HHI may be calculated by squaring the market share of each of the care providers. For example, care provider A holds 100 percent of the market share in region A and, therefore, would have a score of 10,000. By comparison, care provider B1 holds approximately 50 percent of the market share in region B, while care providers B2 and B3 hold approximately 25 of the market share in region B. Accordingly, the HHI of region B is approximately 3,750. Accordingly, the HHI may be utilized to determine a comparative level of consolidation in each of the healthcare regions 10. Although the level of market consolidation is described as being determined based on the HHI, a number of similar methods may be utilized to define the level of consolidation of each of the healthcare regions 10.

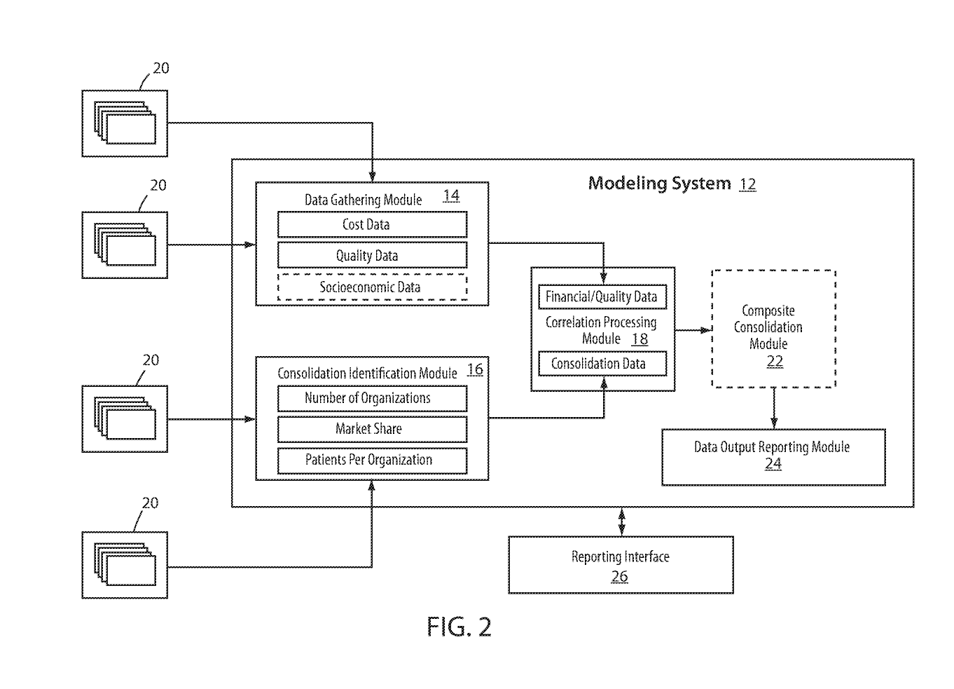

Referring now to FIGS. 1 and 2, a block diagram of a consolidation modeling system 12 may be implemented as a computerized system configured to generate a consolidation influence model for each of the healthcare regions 10. The consolidation modeling system 12 may comprise a data gathering module 14, a consolidation identification module 16, and a correlation processing module 18. In conjunction with one or more systems and/or modules as discussed herein, the consolidation modeling system 12 may be configured to calculate a consolidation influence model for a plurality of healthcare regions 10 based on the consolidation index and one or more care factors of the healthcare regions 10.

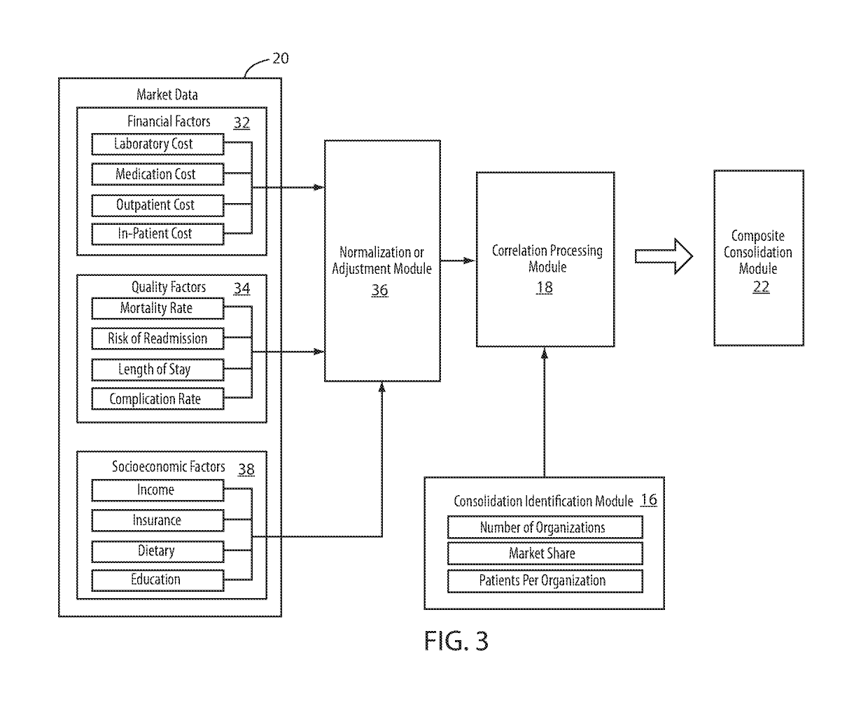

Once the healthcare regions 10 are defined, the modeling system 12 may utilize the data gathering module 14 to access one or more databases 20 to identify or access healthcare and/or socioeconomic data for each of the healthcare regions 10. For example, the data gathering module 14 may be configured to access statistical data representing cost data or quality data representing the quality of healthcare provided in each of the healthcare regions 10. The cost data may comprise a plurality of financial factors including, but not limited to, laboratory costs, medication costs, outpatient treatment costs and/or inpatient treatment costs. The quality data may comprise one or more quality factors including, but not limited to, a mortality rate, a risk of readmission, a length of patient stay and/or a complication rate of patient treatment. Each of the financial factors and quality factors may be referred to as care factors herein to describe a relative level of quality of care provided in each of the healthcare regions by the healthcare providers. Additionally, as further discussed in reference to FIG. 3, the data gathering module 14 may also gather socioeconomic data, which may be utilized to adjust or normalize the cost data and/or quality data for each of the healthcare regions 10 based on community characteristics of the regions 10.

As previously discussed, the methods and systems of the disclosure may provide for accessing and/or calculating a consolidation index for each of the healthcare regions 10. Accordingly, the modeling system 12 may comprise the consolidation identification module 16, which may be configured to calculate the consolidation index for each of the healthcare regions 10. The consolidation identification module 16 may access a plurality of databases 20, which may comprise data indicating market shares, a number of organizations, and a number of patients per organization for each of the healthcare regions 10. Accordingly, the consolidation identification module 16 may utilize the data from the databases 20 to calculate the consolidation index for each of the healthcare regions 10.

The databases 20, as discussed herein, may correspond to a variety of market and/or statistical databases accessible via a network or internet-based connection of the modeling system 12. For example, the databases 20 accessed by the data gathering module 14 may correspond to one or more governmental databases or private databases, which may be maintained by one or more government or private entities. For example, the data gathering module 14 may access databases and/or repositories of the National Library of Medicine, the National Center for Health Statistics, the Agency for Healthcare Research and Quality, the Centers for Medicare and Medicaid Services, etc.

Additionally, consolidation identification module 16 may access consolidation data for each of the healthcare regions 10 via a variety of the databases 20. For example, the databases 20 accessed by the consolidation identification module 16 may comprise the National Library of Medicine, the National Institutes of Health, the National Center for Biotechnology Information, governmentally maintained census data, and a variety of other databases maintained by government and/or private entities. Accordingly, the modeling system 12 may access a variety of databases 20 to identify the consolidation index as well as the financial and quality factors utilized to model the influences of market consolidation on each of the healthcare regions 10. The influences of the market consolidation may then be analyzed by the correlation processing module 18 to generate a consolidation influence model based on the healthcare regions 10.

Once the data gathering module 14 and the consolidation identification module 16 have gathered, data related to at least one care factor and the consolidation index of each of the healthcare regions 10, the correlation processing module 18 may identify a correlation between the at least one care factor indicated from the financial and/or quality data and the consolidation index identified from the consolidation data. For example, the correlation processing module 18 may be configured to receive data for each of the healthcare regions 10 identifying a risk of adjusted mortality rate as the least one care factor utilized to process the consolidation influence model. The correlation processing module 18 may also receive the consolidation index or consolidation data for each of the healthcare regions 10. Based on the data provided by the data gathering module 14 and the consolidation identification module 16, the correlation processing module 18 may calculate a statistical correlation of the risk adjusted mortality rate (i.e. the at least one care factor) to the consolidation index in each of the regions 10. Based on the correlation between the at least one care factor and the consolidation index for each of the regions 10, the system 12 may generate a consolidation influence model.

The statistical correlation of the at least one care factor in the particular example of the risk adjusted mortality rate may be calculated via logistic regression based on the consolidation index with data for each of the healthcare regions 10. In this way, the correlation processing module 18 of the modeling system 12 may be configured to generate a consolidation influence model indicating a relationship between the risk adjusted mortality rate and the consolidation index. Accordingly, the disclosure may provide for the generation of a consolidation influence model that may be applied as a predictive model and/or an explanatory tool or reference model for research studies and analysis.

The at least one care factor analyzed by the correlation processing module 18 may correspond to a wide variety of care factors based on cost data and/or quality data gathered by the data gathering module 14. For example, in some embodiments, the correlation processing module 18 may calculate a correlation between the consolidation data and a plurality of care factors to generate consolidation influence models for each of the care factors in relation to the consolidation data. Accordingly, the modeling system 12 may further comprise a composite consolidation module 22 configured to generate a composite consolidation influence model based on the plurality of care factors in relation to the consolidation index. The composite consolidation module 22 may combine the individual consolidation influence models for each of the plurality of care factors based on a level of correlation between each of the care factors and the consolidation index for each of the healthcare regions. Additionally, the composite consolidation module 22 may be configured to emphasize the effects of one or more care factors of interest by weighting each of the care factors emphasizing the care factors of interest.

For example, in operation, the correlation processing module 18 may calculate a consolidation influence model for each of a plurality of care factors based on the consolidation index for each of the regions. The care factors may include a variety of financial factors and/or quality factors as discussed herein. In a particular example, the care factors incorporated in a composite consolidation influence model may include laboratory costs, mortality rate, and length of stay. The correlation processing module 18 may process each of the plurality of care factors based on a statistical regression or similar techniques to identify a correlation between of each of the plurality of care factors and the consolidation index with data from each of the plurality of regions 10. Once the consolidation influence models for each of the plurality of care factors are calculated by the correlation processing module 18, the composite consolidation module 22 may combine the consolidation influence models to provide a composite score incorporating each of the plurality of care factors (e.g. laboratory cost, mortality rate and length of stay). In this way, the modeling system 12 may utilize the composite consolidation module 22 to generate a composite model attributing variations in each of the plurality of care factors to variations or changes in the consolidation index in the various healthcare regions 10.

The correlation processing module 18 may calculate the correlation between each of the care factors and the consolidation index based on a variety of statistical regression techniques or similar techniques. For example, logistic regression may be utilized to calculate the correlation between the consolidation index and the mortality rate or risk of readmission. Additionally, the correlation processing module 18 may utilize linear regression to calculate a correlation between the consolidation index and a length of stay, a laboratory cost, and various financial or cost factors as discussed herein. Accordingly, the correlation processing module 18 may be utilized to calculate consolidation influence models for each of the care factors to model relationships between or among the care factors and the consolidation index.

Additionally, the modeling system 12 may further comprise a data output and reporting module 24 and a reporting interface 26. The data output and reporting module 24 may be configured to communicate data, such as the consolidation influence model or related scores for the at least one care factor to the reporting interface 26. Accordingly, the output and reporting module 24 may be configured to generate a number of reports and/or generate data for display in an interactive graphical user interface of the reporting interface 26. The reporting interface 26 may correspond to a computer terminal or interactive computer system configured to present a graphical depiction of the consolidation influence model generated by the modeling system 12. In this configuration, modeling system 12 may output information related to the consolidation influence model via the reporting interface 26, which may be accessed by a variety of users of the system 12.

Referring now to FIG. 3, a detailed process diagram demonstrating a method for identifying a consolidation influence model is shown. As previously discussed, the correlation processing module 18 may be configured to perceive and/or access cost data and/or quality data corresponding to a plurality of financial factors 32 and/or quality factors 34 indicating a relative level of quality of care of the care providers in each of the healthcare regions 10. The correlation processing module 18 may further be in communication with the consolidation identification module 16. The consolidation identification module 16 may be configured to access and/or calculate a consolidation index for each of the healthcare regions 10 based on one or more of the consolidation identification techniques (e.g. HHI). Accordingly, with the quality of care data represented by one or more of the financial factors 32 or quality factors 34 and the consolidation index for each of the healthcare regions 10, the correlation processing module 18 may be configured to generate a consolidation influence model for each of the care factors. In this way, the modeling system 12 may provide for individual or composite consolidation influence models from the correlation processing module 18 and/or the composite consolidation module 22 providing beneficial insight into the effects of the level of consolidation of a healthcare region on the one or more care factors.

Additionally, in some embodiments, the modeling system 12 may further comprise a normalization or adjustment module 36. The adjustment module 36 may be applied by the modeling system 12 to adjust the data associated with the care factors (e.g. the financial factors 32 and the quality factors 34) for various socioeconomic factors 38. The adjustment module 36 may adjust the data to limit the impact of extraneous factors, which may skew or cause variation that may not be attributable to the level of consolidation of each of the healthcare regions 10. For example, the adjustment module 36 may access income data for each of the healthcare regions 10 and adjust data related to the financial factors 32 and/or quality factors 34 based on the income data from the socioeconomic factors 38. More specifically, the adjustment module 36 may adjust or decrease quality factors 34, such as the mortality rate and/or risk of readmission in low income healthcare regions 10 to offset limitations of the healthcare provided in such regions that are not related to the quality provided by the care providers 54. Similarly, financial factors 32 and other quality factors 34 may be adjusted by the adjustment module 36 based on socioeconomic factors 38 including, but not limited to, income, level of insurance coverage, dietary quality, education, etc. In this way, the adjustment module 36 of the modeling system 12 may provide for the data related to the care factors (e.g. financial factors 32 and quality factors 34) to be adjusted such that the data processed by the correlation processing module 18 for the care factors accurately reflects variations in healthcare quality among the healthcare regions 10 independent of the socioeconomic factors 38. In this way, the modeling system 12 may provide for improved accuracy of the consolidation models calculated to provide predictions and results configured to accurately describe the independent effects of market consolidation on the quality of care provided to patients in one or more healthcare regions of interest.

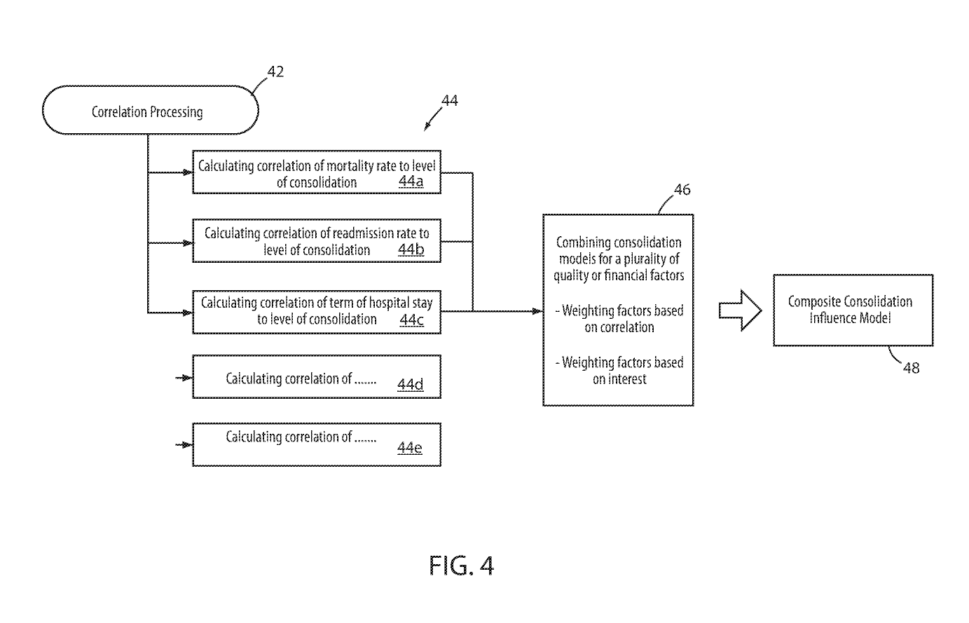

Referring now to FIG. 4, a method of correlation processing which may be applied by the modeling system 12 is shown. The method demonstrated in FIG. 4 may be applied by the correlation processing module 18 and may begin with step 42 to calculate a composite consolidation influence model. As previously discussed, the correlation processing module 18 may receive data related to a plurality of care factors from the data gathering module 14 and consolidation data from the consolidation identification module 16 for each of the healthcare regions 10. The correlation processing module 18 may then calculate a consolidation influence model for each of the care factors describing a correlation of the care factors of a level of consolidation indicated in each of the healthcare regions 10.

As demonstrated in FIG. 4, the method may calculate a plurality of consolidation influence models in step 44. The method may calculate the correlation of exemplary care factors (e.g. mortality rate, readmission rate, term of hospital stay, etc.) in relation to a level of market consolidation or the consolidation index for each of the healthcare regions 10 in steps 44a, 44b, 44c, 44d, 44e, etc. Once the correlation processing module 18 has calculated each of the consolidation influence models based on the care factors represented in step 44, the method may continue by applying the composite consolidation module 22 to combine each of the consolidation influence models for the plurality of care factors in step 46.

Additionally, as previously discussed, the composite consolidation module 22 may apply waiting factors based on correlation coefficients or correlation levels of each of the plurality of factors to combine the consolidation influence models into a composite score or composite consolidation influence model. In this way, the composite consolidation influence model may be configured to describe a relationship between the consolidation level of healthcare region of interest and each of the care factors. As previously discussed, each of the care factors may be weighted based on a level of correlation of each of the care factors to the level of consolidation.

Additionally, one or more of the care factors may be weighted based on a level of interest or perceived benefit of each of the care factors. For example, a care provider interested in the results of the composite consolidation influence model may be particularly interested in mortality rates and readmission rates but also prefer that the consolidation influence model incorporate a correlation between a term of hospital stay and a level of consolidation. Accordingly, the composite consolidation influence model may include an increased weighting factor to each of the mortality rate and the readmission rate while incorporating a decreased waiting factor for the term of hospital stay as coefficients for each of the individual consolidation influence models of the care factors. Accordingly, the consolidation influence model 48 may be customized based on an interest in one or more particular care factors and/or a correlation of the care factors to the consolidation of a healthcare region of interest.

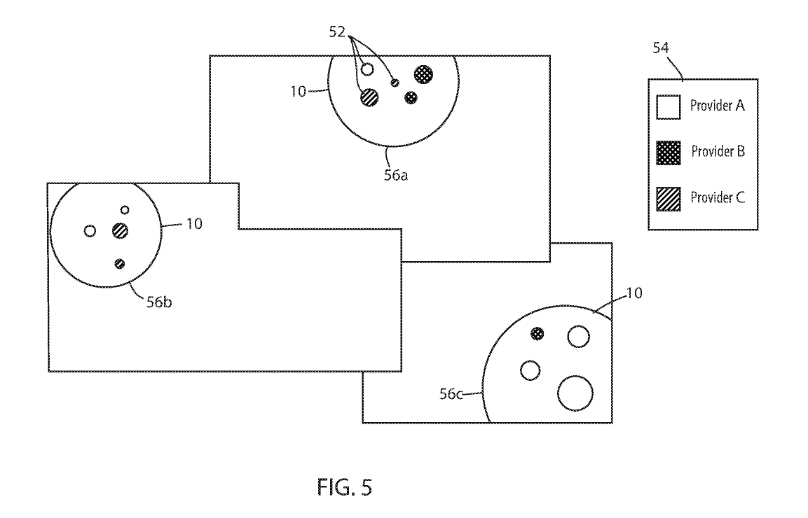

Referring now to FIG. 5, a schematic diagram demonstrating a plurality of geographic regions 10 is shown. Each of the geographic regions 10 may comprise one or more medical centers 52, which may be operated by a healthcare provider 54. For example, as demonstrated in FIG. 5, the healthcare organizations are represented by different fill patterns within the medical centers 52 and denoted as organization A, organization B, and organization C. Based on this representation, the modeling system 12 may provide beneficial information to one or more of the care providers 54 to research the relationships among the care providers 54 and their resulting effects on the quality of care provided in each of the regions 10.

In some embodiments, the modeling system 12 may generate one or more consolidation influence models identifying a quality of care provided by each of a first level of consolidation 56a, a second level of consolidation 56b, and a third level of consolidation 56c. Based on the consolidation influence model, a quality of care provided by each of the providers 54 resulting from each of the levels of consolidation 56a, 56b, and 56c may be compared and analyzed. Accordingly, the modeling system 12 may provide for the analysis of the effects of market consolidation of one or more care providers 54 on one or more of the care factors (e.g. financial factors 32 and quality factors 34) as discussed herein.

Additionally, the methods and systems discussed herein may further provide for predictions that may allow for one or more of the care providers 54 to predict a change in a healthcare quality provided within each of the healthcare regions 56a, 56b, and 56c. For example, a particular use case of the modeling system 12 may include a determination by provider A identifying or predicting the changes in quality of care (e.g. financial factors 32 and quality factors 34) that may result in healthcare region 56c by purchasing or merging with provider B. Accordingly, modeling system 12 may generate a consolidation influence model and provide a prediction indicating a change or changes in the quality of care in the healthcare region 56c that likely will result from the increase in consolidation caused by provider A merging with or purchasing provider B. The prediction may be processed by the modeling system 12 based on the correlations of each of the care factors in a plurality of the healthcare regions 10 to the consolidation index in each of the healthcare regions. In this way, the modeling system 12 may provide for beneficial insight to one or more care providers 54 or users predicting the outcome or changes in a quality of care for one or more care factors due to a variation or change in the consolidation level of one or more healthcare regions.

The prediction may further be applied by the system 12 to initiate a transaction (e.g. a purchase or sale) of one or more healthcare providers of interest in a healthcare region. The healthcare providers of interest may be identified by the system 12 and/or input to the system via the reporting interface 26. For example, the system may output a proposed transaction of one or more of the medical centers 52 or care providers 54 based on a prediction or forecast of a prospective or future change in the quality of care indicated by the consolidation influence model. In operation, the system may utilize the consolidation influence model or composite consolidation influence model to forecast or predict the change in quality of care in a region of interest in response to an increase in consolidation. Accordingly, the system 12 may be configured to predict and propose or initiate a transaction based on the consolidation influence model 48, which may be utilized by a care provide to improve a quality of care by adjusting a level of market consolidation in a region of interest.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals, per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language, such as Smalltalk, C++, or the like, and procedural programming languages, such as the “C” programming language, or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry, including, for example, programmable logic circuitry, field-programmable gate arrays (FPGA), or programmable logic arrays (PLA), may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computerized method for determining a market consolidation strategy for a healthcare market, the method comprising:
identifying, by a processor, a plurality of healthcare regions comprising healthcare providers;
accessing, by the processor, at least one database comprising a plurality of healthcare statistics of a plurality of patients in the plurality of healthcare regions;
calculating, by the processor, a consolidation index for each of the healthcare regions, wherein the consolidation index indicates a level of diversity of the healthcare providers in each of the healthcare regions;
calculating, by the processor, a correlation of at least one care factor of the healthcare statistics to the consolidation index of each of the plurality of healthcare regions;
generating, by the processor, a consolidation influence model for the at least one care factor based on the correlation, wherein the consolidation influence model identifies a relationship between the at least one care factor and the consolidation index among the plurality of healthcare regions; and
receiving, by the processor, an indication of a healthcare region of interest;
calculating, by the processor, based on the consolidation influence model, a consolidation prediction for the healthcare region of interest; and
controlling, by the processor, an output of the consolidation prediction via a reporting interface.

2. The computerized method according to claim 1, further comprising:
receiving a proposed change in the consolidation index of the healthcare region of interest.

3. The computerized method according to claim 2, wherein the consolidation prediction comprises a forecast of a change of the at least one care factor based in response to the proposed change in the consolidation index of the healthcare region of interest.

4. The computerized method according to claim 1, wherein the consolidation index identifies a level of diversity of the healthcare providers in each of the healthcare regions.

5. The computerized method according to claim 4, wherein the level of diversity is defined by a number of the healthcare providers in each of the healthcare regions and percent market share of each the healthcare providers.

6. The computerized method according to claim 1, further comprising:
adjusting the correlation of the at least one care factor of the healthcare statistics by comparing at least one socioeconomic factor of each of the healthcare regions.

7. The computerized method according to claim 6, wherein the adjusting the correlation further comprises adjusting a value of the at least one care factor for each of the healthcare regions based on the comparison of the at least one socioeconomic factor.

8. The computerized method according to claim 6, wherein the at least one socioeconomic factor comprises at least one of an average income, a percent insurance coverage, and an education level for each of the healthcare regions.
